(19) United States
(12) Patent Application Publication
(10) Pub. No.: US 2007/0219961 A1
(43) Pub. Date: Sep. 20, 2007

(54) Scientific research workbench

(75) Inventors: Frank Burgel, Scarsdale, NY (US); Mark C. Salamon, Bayside, NY (US)

Correspondence Address: NIXON & VANDERHYE, PC, 901 NORTH GLEBE ROAD, 11TH FLOOR, ARLINGTON, VA, 22203, US

(73) Assignee: SciFor Inc., Brewster, NY (US)

(21) Appl. No.: 11/526,248

(22) Filed: Sep. 25, 2006

Related U.S. Application Data
(60) Provisional application No. 60/719,744, filed on Sep. 23, 2005.

(51) Int. Cl. G06F 17/30

(52) U.S. Cl. 707/3

(57) ABSTRACT

Scientific research and collaboration can be performed over a network using a client device. The user generates a search query including a search term. A preliminary search result is received including one or more web documents distributed over the network in response to the search query. The preliminary search result is analyzed for additional terms, and a list of the additional terms including a frequency indication is displayed. The user can then narrow the preliminary search result to a final search result with Boolean criteria using the additional terms. The final search result is then displayed. Other features facilitate communication and collaboration among scientists to improve research and publication capabilities.

### CROSS-REFERENCES TO RELATED APPLICATIONS

This application claims the benefit of U.S. Provisional Patent Application Ser. No. 60/719,744, filed Sep. 23, 2005, the entire content of which is herein incorporated by reference.

### STATEMENT REGARDING FEDERALLY SPONSORED RESEARCH OR DEVELOPMENT

(Not Applicable)

### BACKGROUND OF THE INVENTION

The present invention relates to a search engine and user system for conducting and processing search queries for researching scientific publications and information.

Scientists using the Internet for their research and publishing needs have specific requirements that are different from those of the typical Internet search engine user. In addition, scientists form a global community, typically subdivided into the respective specialties. Still further, the material that scientists review and process are highly technical in nature and vocabulary.

Scientific research and publishing are demanding in terms of both time and intelligence, and there are few tools available on the Internet specifically designed for scientists to assist them in their research and publishing efforts. This problem is compounded by the fact that while English is the standard language of science, an increasing number of scientists and researchers are not native English speakers.

It would be desirable to develop a global Internet approach for the scientific community that appreciates and addresses these concerns.

### BRIEF SUMMARY OF THE INVENTION

The scientific workbench described herein provides a new approach to scientific research and collaboration. Users are provided with a platform that can be fully secured and where research and research collaboration can be performed. In addition to communication and file sharing capabilities, a search engine results tool can gather the results of a scientific Internet search and, if desired, analyze and categorize the search results to assist the user in narrowing the search results. Once a search term has been entered, the search tool conducts a preliminary search and displays a list of additional terms with a percentage indicator showing the frequency that these additional terms appear in the results. The researcher can then add the additional terms using Boolean operators or the like to further narrow and focus their search.

In an exemplary embodiment of the invention, a method performed by a client device for performing scientific research and collaboration over a network includes the steps of a user generating a search query including a search term; receiving a preliminary search result including one or more web documents distributed over the network in response to the search query; analyzing the preliminary search result for additional terms and displaying a list of the additional terms including a frequency indication; enabling a user to narrow the preliminary search result to a final search result with Boolean criteria using the additional terms; and displaying the final search result.

The final search result may be stored in a user accessible account. In this context, the method may further include a step of enabling the user to modify the search term or the additional terms used for generating the preliminary search result and the final search result, respectively. Alternatively, the system may periodically automatically update the final search result and store the updated final search result in the user accessible account.

The method may further include the steps of enabling communication with at least one other client device; and enabling file sharing with the at least one other client device. The final search results may then be communicated to the at least one other client device.

The additional terms from the preliminary search result may include at least one of author name, publication name, and publication date.

In another exemplary embodiment of the invention, a method of managing a scientific workbench system for access by a client device over a network includes the steps of enabling users to establish user accounts providing access to a workbench search engine; enabling communication with at least one other client device; and enabling file sharing with the at least one other client device.

### BRIEF DESCRIPTION OF THE DRAWINGS

These and other aspects and advantages of the present invention will be described in detail with reference to the accompanying drawings, in which:

FIG. 1 is a diagram of an exemplary network in which systems and methods consistent with the present invention may be implemented;

FIG. 2 is an exemplary diagram of a client of FIG. 1 in an implementation consistent with the present invention;

FIG. 3 is a diagram of an exemplary computer-readable medium used by the clients of FIG. 1 according to an implementation consistent with the present invention;

FIG. 4 is an exemplary diagram of a graphical user interface that includes the browser assistant of FIG. 3 according to an implementation consistent with the present invention;

FIG. 5 is an exemplary diagram of a server of FIG. 1 according to an implementation consistent with the present invention;

FIG. 6 is a flow diagram illustrating the search engine results tool;

FIG. 7 is a flow diagram illustrating a push center for delivering and processing results;

FIG. 8 illustrates communications center capabilities;

FIG. 9 illustrates resource sharing capabilities;

FIG. 10 is a block diagram summarizing workbench results;

FIG. 11 illustrates processing functionality of the search results; and

FIG. 12 is a block diagram illustrating specific functionality for a drug search.

### DETAILED DESCRIPTION OF THE INVENTION

Details of search engine infrastructure enabling Internet searching are known and do not necessarily form part of the invention. Any suitable known infrastructure may be utilized. Many examples of suitable infrastructure are described in existing U.S. patents. See, for example, U.S. Pat. No. 6,839,702.

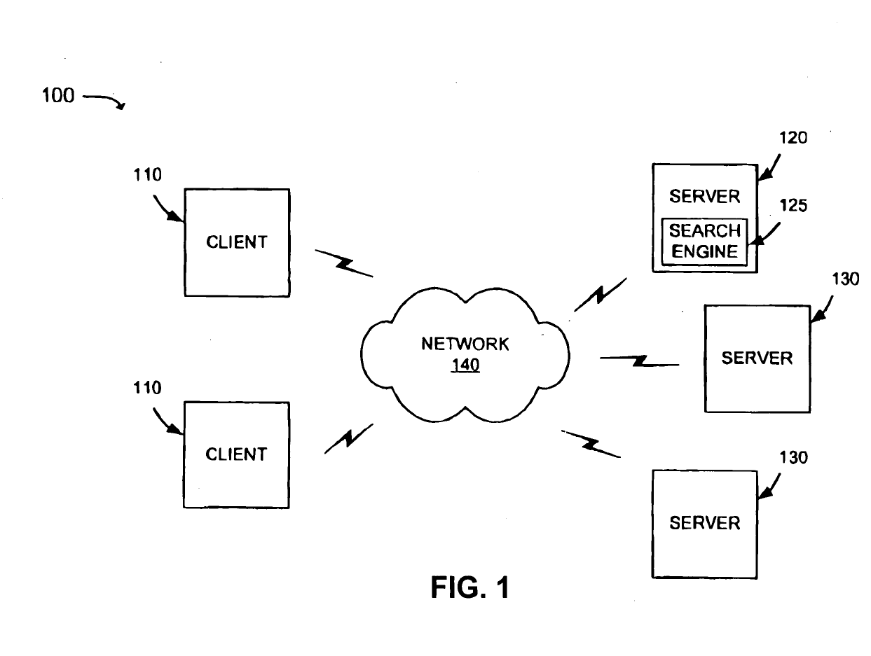

FIG. 1 is an exemplary diagram of a network 100 in which systems and methods consistent with the present invention may be implemented. The network 100 may include multiple clients 110 connected to multiple servers 120-130 via a network 140. The network 140 may include a local area network (LAN), a wide area network (WAN), a telephone network, such as the Public Switched Telephone Network (PSTN), an intranet, the Internet, a similar or dissimilar network, or a combination of networks. Two clients 110 and three servers 120-130 have been illustrated as connected to network 140 for simplicity. In practice, there may be more Or less clients and servers. Also, in some instances, a client may perform the functions of a server and a server may perform the functions of a client.

The clients 110 may include devices, such as wireless telephones, personal computers, personal digital assistants (PDAs), lap tops, etc., threads or processes running on these devices, and/or objects executable by these devices. The servers 120-130 may include server devices, threads, and/or objects that operate upon, search, or maintain documents in a manner consistent with the present invention. The clients 110 and servers 120-130 may connect to the network 140 via wired, wireless, or optical connections.

In an implementation consistent with the present invention, the server 120 may include a search engine 125 usable by the clients 110. The servers 130 may store documents accessible by the clients 110.

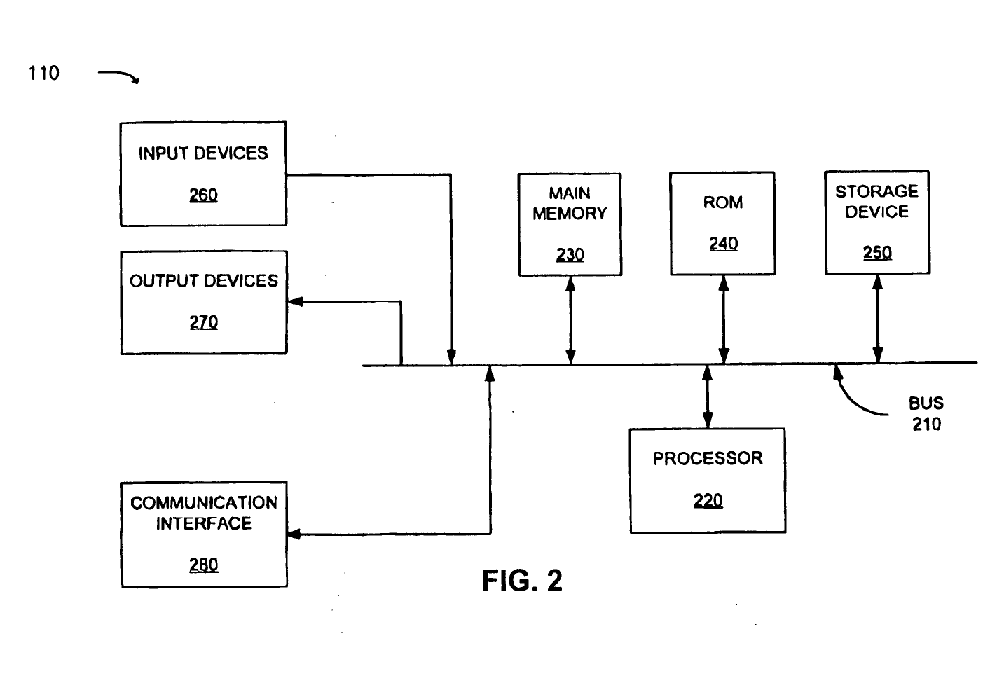

FIG. 2 is an exemplary diagram of a client 110 in an implementation consistent with the present invention. The client 110 may include a bus 210, a processor 220, a main memory 230, a read only memory (ROM) 240, a storage device 250, one or more input devices 260, one or more output devices 270, and a communication interface 280. The bus 210 may include one or more conductors that permit communication among the components of the client 110.

The processor 220 may include any type of conventional processor or microprocessor that interprets and executes instructions. The main memory 230 may include a random access memory (RAM) or another type of dynamic storage device that stores information and instructions for execution by the processor 220.

The ROM 240 may include a conventional ROM device or another type of static storage device that stores static information and instructions for use by the processor 220. The storage device 250 may include a magnetic and/or optical recording medium and its corresponding drive.

The input devices 260 may include one or more conventional mechanisms that permit a user to input information to the client 110, such as a keyboard, a mouse, a pen, voice recognition and/or biometric mechanisms, etc. The output devices 270 may include one or more conventional mechanisms that output information to the user, including a display, a printer, a speaker, etc. The communication interface 280 may include any transceiver-like mechanism that enables the client 110 to communicate with other devices and/or systems. For example, the communication interface 280 may include mechanisms for communicating with another device or system via a network, such as network 140.

As will be described in detail below, the clients 110, consistent with the present invention, perform certain searching-related operations. The clients 110 may perform these operations in response to processor 220 executing software instructions contained in a computer-readable medium, such as memory 230. A computer-readable medium may be defined as one or more memory devices and/or carrier waves.

The software instructions may be read into memory 230 from another computer-readable medium, such as the data storage device 250, or from another device via the communication interface 280. The software instructions contained in memory 230 causes processor 220 to perform processes that will be described later. Alternatively, hardwired circuitry may be used in place of or in combination with software instructions to implement processes consistent with the present invention. Thus, the present invention is not limited to any specific combination of hardware circuitry and software.

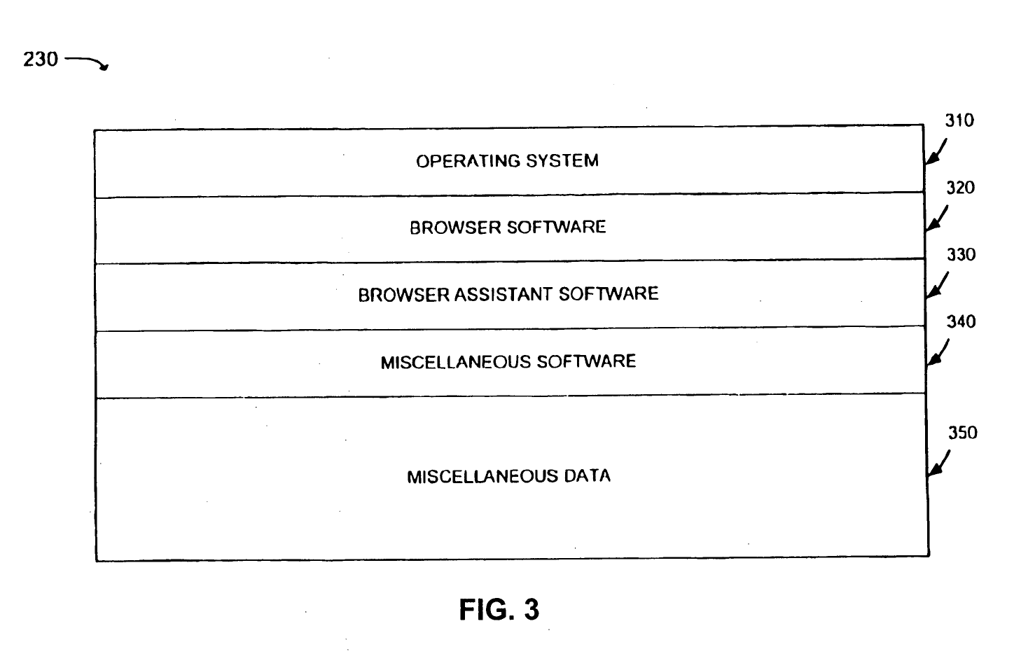

FIG. 3 is a diagram of an exemplary computer-readable medium used by the clients 110 according to an implementation consistent with the present invention. In this implementation, the computer-readable medium includes memory 230. The memory 230 may include an operating system 310, browser software 320, browser assistant software 330, miscellaneous other software 340, and miscellaneous data 350.

The operating system 310 may include conventional operating system software, such as the Windows, Unix, or Linux operating systems. The browser software 320 may include conventional web browser software, such as the Microsoft Internet Explorer or Netscape Navigator browsers.

The browser assistant software 330 may include a plug-in, an applet, a dynamic link library (DLL), or a similar executable object or process. The client 10 may obtain the plug-in from the server 120 or from a third party server, disk, tape, network, CD-ROM, etc. Alternatively, the plug-in may be pre-installed on the client 110.

In another implementation consistent with the present invention, the browser assistant 330 is part of the browser 320. In this implementation, the browser 320 performs the functions of the browser assistant 330. In yet another implementation, the browser assistant 330 is a process separate from and runs concurrently with the browser 320. In this implementation, the browser assistant 330 may interface between the browser 320 and the network 140.

The browser assistant 330 may be automatically activated upon initiation of the browser 320. Alternatively, the browser assistant 330 may be activated when instructed by a user. In either case, the browser assistant 330 may take the form of a graphical user interface, such as a tool bar, software button, or menu, that provides an extension to the browser 320.

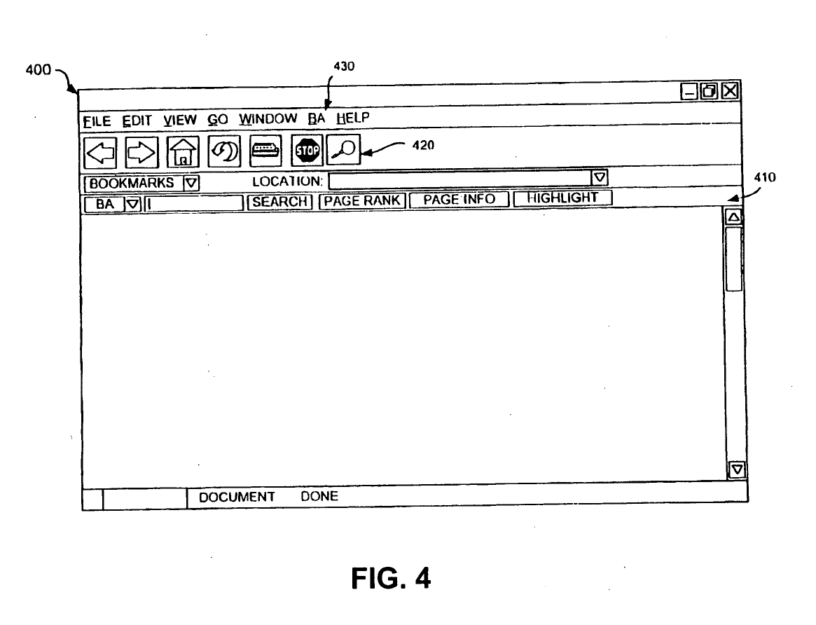

FIG. 4 is an exemplary diagram of a graphical user interface 400 that includes a browser assistant (BA) 330 according to an implementation consistent with the present invention. The graphical user interface 400 illustrated in FIG. 4 shows three forms of the browser assistant 330: a tool bar 410, a software button 420, and a menu 430. The browser assistant 330 may take other forms.

The tool bar 410 includes software buttons and/or menus selectable by a user to initiate different functions of the browser assistant 330. In this case, a user may activate a function of the browser assistant 330 by selecting one of the software buttons and/or menus. The software button 420 may be selectable by a user to initiate the browser assistant 330 functionality. In this case, a user may activate a function of the browser assistant 330 by selecting the button using, for example, a mouse. The menu 430 may provide a list of functions that the browser assistant 330 is capable of performing. A user may select from the list to activate the browser assistant 330 and instruct the browser assistant 330 to perform the desired function.

As described in more detail below, the browser assistant 330 may perform many searching-related functions to enhance a user's search experience. The browser assistant 330 may attach to the browser 320 to provide additional functionality to the user.

Returning to FIG. 3, the miscellaneous other software 340 and miscellaneous data 350 may include programs and data used by the client 110 to perform searching-related and non-searching-related operations.

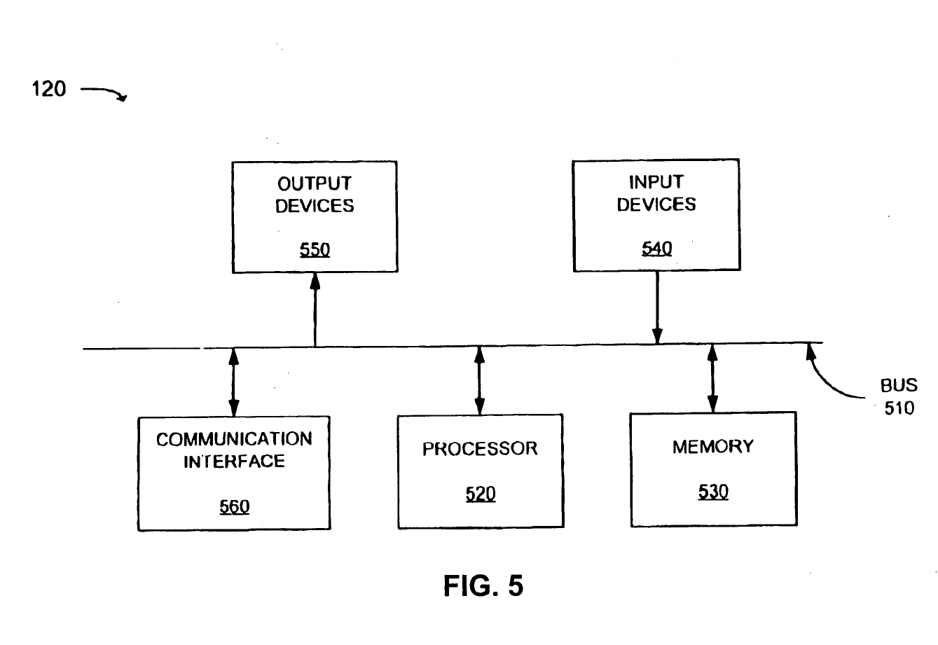

FIG. 5 is an exemplary diagram of the server 120 according to an implementation consistent with the present invention. The servers 130 may be similarly configured.

The server 120 may include a bus 510, a processor 520, a memory 530, one or more input devices 540, one or more output devices 550, and a communication interface 560. The bus 510 permits communication among the components of the server 120. The processor 520 may include any type of conventional processor or microprocessor that interprets and executes instructions. The memory 530 may include a RAM or another type of dynamic storage device that stores information and instructions for execution by the processor 520; a ROM or another type of static storage device that stores static information and instructions for use by the processor 520; and/or some other type of magnetic or optical recording medium and its corresponding drive.

The input devices 540 may include one or more conventional mechanisms that permit an operator to input information into the server 120, such as a keyboard, mouse, pen, etc. The output devices 550 may include one or more conventional mechanisms that output information to the operator, including a display, a printer, a speaker, etc. The communication interface 560 may include any transceiver-like mechanism that enables the server 120 to communicate with other devices and systems via a network, such as the network 140.

As will be described in detail below, the server 120, consistent with the present invention, performs certain searching-related operations. The server 120 may perform these operations in response to processor 520 executing software instructions contained in a computer-readable medium, such as memory 530. The software instructions may be read into memory 530 from another computer-readable medium or from another device via the communication interface 560. The software instructions contained in memory 530 causes processor 520 to perform processes that will be described later. Alternatively, hardwired circuitry may be used in place of or in combination with software instructions to implement processes consistent with the present invention. Thus, the present invention is not limited to any specific combination of hardware circuitry and software.

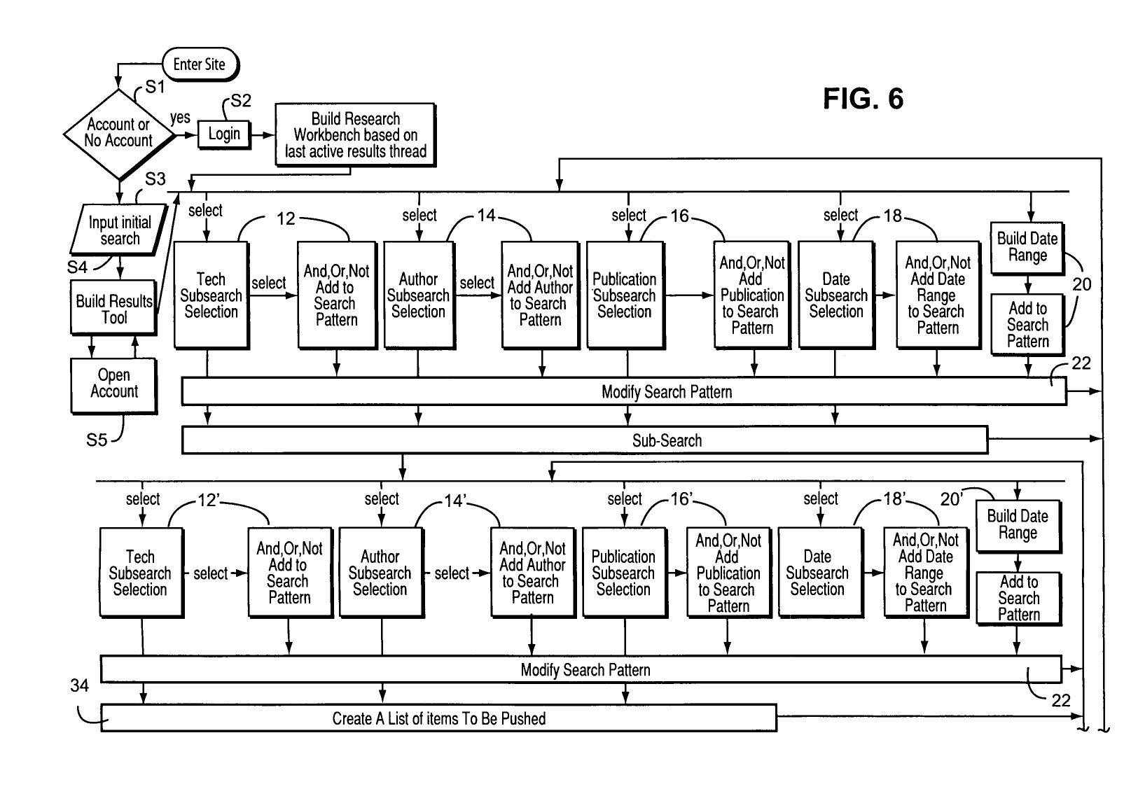

FIG. 6 is a flow diagram of the search engine results tool. After accessing the site, the system queries whether the user has an account (step S1), and if so, enables the user to log in (S2). Whether the user has an account or not, the user can access a search window to generate a search query including a search term (S3). Users with accounts can similarly generate a search query, but additionally have access to prior searches and other features of this system described in more detail below. Those users without accounts before or after using the results tool (S4), may be provided with an opportunity to open an account if desired (S5).

The system processes the search query, and a preliminary search result is received including one or more web documents distributed over the network in response to the search query. The preliminary search results may be displayed for user access or may be hidden prior to narrowing the preliminary search to a final search result. The system analyzes the preliminary search results for additional terms and displays a list of the additional terms including a frequency indication. Preferably, the frequency indication is expressed as a percentage of non stopwords used in a predefined portion of the document, such as the title, abstract, summary, etc. The system stores a standard list of stopwords that are disregarded in the frequency indication (e.g., a, an, and, the, etc.).

The additional terms may include technical terms appearing in the preliminary search results and/or categories including, without limitation, author name, publication name, publication date, and publication date range. The system enables the user to narrow the preliminary search result to a final search result with Boolean criteria using the additional terms. FIG. 6 illustrates exemplary additional terms and selectable Boolean criteria including technical terms 12, author name 14, publication name 16, publication date 18, and publication date range 20.

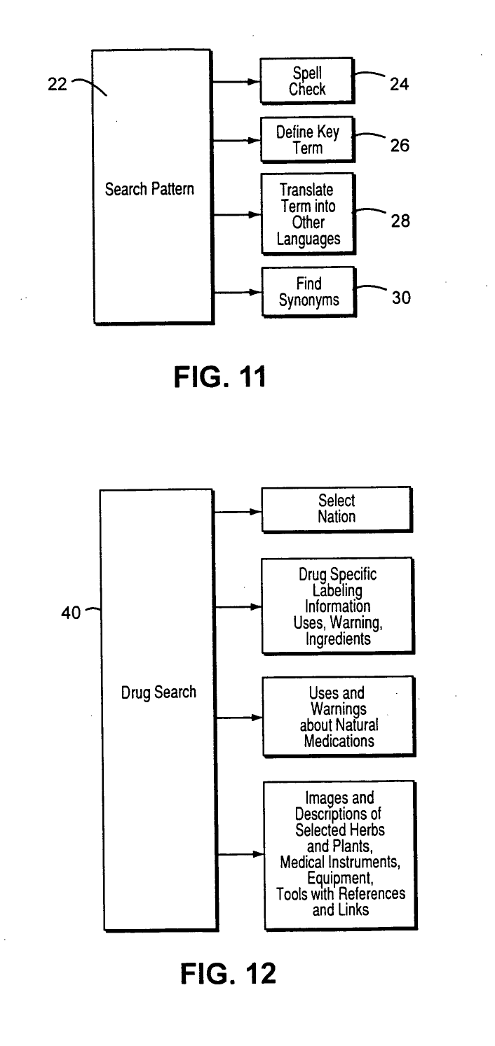

The system enables the user further to modify search patterns 22, including, without limitation, spell check 24, defining key terms 26, translating terms into other languages 28, finding synonyms 30, and the like (see FIG. 11).

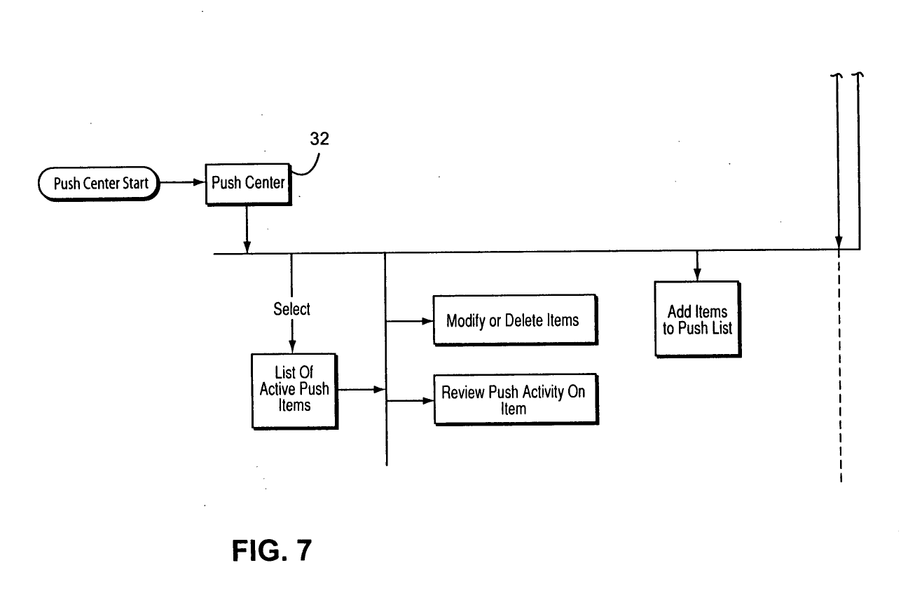

With reference to FIG. 7, those narrowed search results may then be pushed (i.e., displayed or otherwise delivered) by a push center 32. The once-narrowed search results may still further be narrowed utilizing additional terms from the once-narrowed search result and so on (see FIG. 6, blocks 12′, 14′, 16′, 18′, and 20′). Ultimately, the final search result including a list of relevant items is pushed to the user (see block 34). The user is provided the ability to add, modify, review or delete items to/from the push list for further processing or future reference (FIG. 7).

With reference to FIG. 10, the workbench system via a workbench results component 35 can store and display the search results. The results of a scientist's entire search history can be easily recalled, manipulated and resubmitted. Analysis of references returned by search results will allow the workbench to provide a historical path for selective research by providing a weighted bibliography. In this way, the most relevant references to a subject can be identified. Searches can be saved by user name and password. Additionally, searches can be saved by defined categories. The user can retrieve an old search and make changes in one or more categories. For example, a search can be retrieved in order to change the dates but leave the rest of the search “as is.”

Each result can be manipulated. Users have the option of deleting unwanted results from their workbench and saving the rest. In addition, saved results can be emailed to others with active links so the recipient of the email can also access the results. The workbench system allows the user to configure and save personal settings including frequently used links and email addresses. Users can request this system to supply them with links to the latest published results regarding specific research (automatic update facility), using the same search criteria facilities described above.

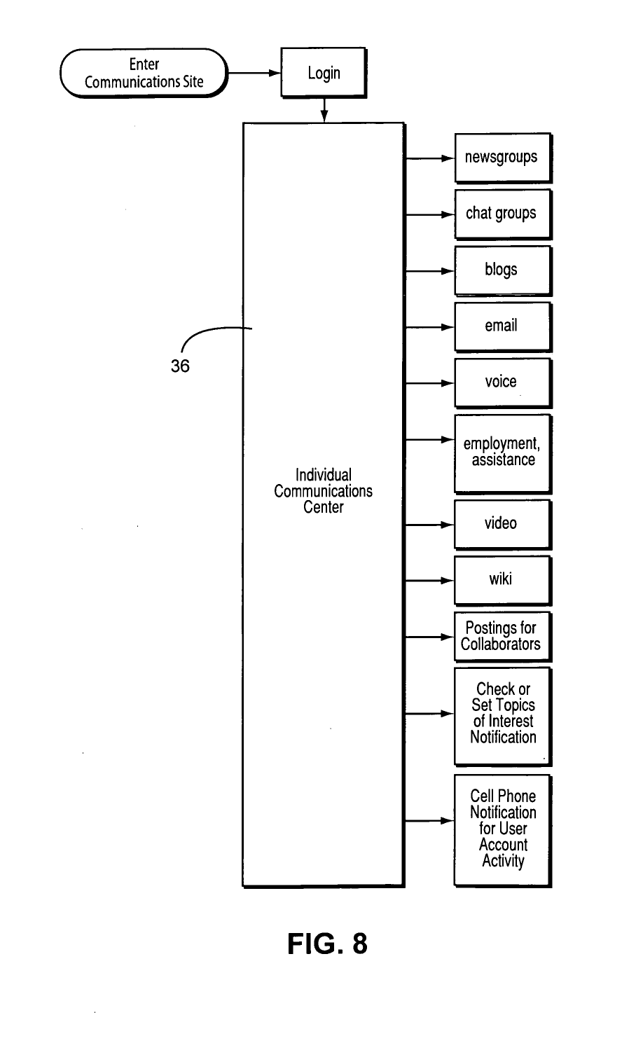

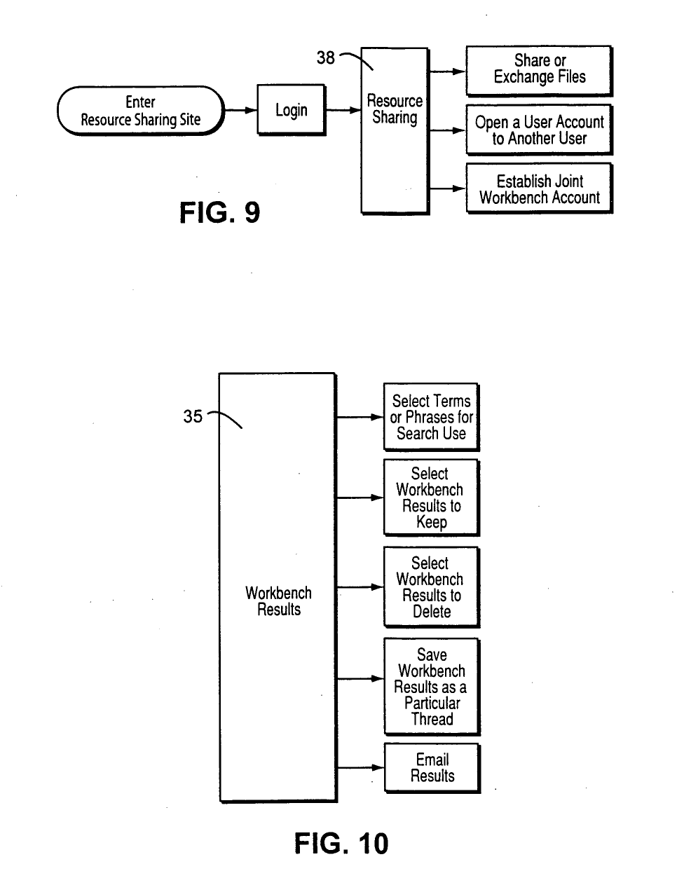

FIG. 8 illustrates a communications center 36 enabling communication with at least one other client device. The user can hold public or private communications with any one person or group of people. Communication is available via any suitable means, including, without limitation, instant messaging, email, threaded discussion groups, blogs, voice, video and the like. Regardless of their location, collaborators on a research project can securely share files and data with anyone they choose to allow entry into the workbench or, alternatively, create a “shared” workbench. See resource sharing component 38 in FIG. 9.

Users can publicly post requests for help or collaborators. Additionally, users can publicly post requests for any commercial product that would help their research.

FIG. 12 illustrates a drug search component 40 of the workbench system. Pharmaceutical drugs and other remedies are typically identified by different names that vary from country to country. The workbench system will be able to easily provide these various names. Clicking on a selected drug will cause a list of countries to appear. From that list, a country can be selected and the user can view the name of the drug, instrument, etc. in that country. Conversely, one can select a country and all drugs, etc. will appear automatically with the local naming conventions.

If the user has speakers attached to his computer, the system can pronounce a selected word in the English language.

The workbench system may also provide the user with drug specific labeling information such as uses, warnings, directions and ingredients. The system may also provide the user with the ability to quickly identify the uses, warnings and directions for “natural” medicines, herbs and plants. The workbench can provide translations of “natural” medicines, herbs and plants (i.e., common English names, Latin description, national terms, etc.). The system provides images and descriptions of selected herbs and plants, medical instruments, equipment, tools, etc. with references and connections to relevant suppliers, importers and/or manufacturers.

The scientific research workbench described herein serves as a valuable tool for scientific research and collaboration. The system includes a search engine that helps users narrow search results and identify relevant web documents. The added functionality including communication and collaboration functions make the tool a valuable scientific resource.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method performed by a client device for performing scientific research and collaboration over a network, the method comprising:
a user generating a search query including a search term;
receiving a preliminary search result including one or more web documents distributed over the network in response to the search query;
analyzing the preliminary search result for additional terms and displaying a list of the additional terms including a frequency indication;
enabling a user to narrow the preliminary search result to a final search result with Boolean criteria using the additional terms; and
displaying the final search result.

2. A method according to claim 1, further comprising storing the final search result in a user accessible account.

3. A method according to claim 2, further comprising enabling the user to modify the search term or the additional terms used for generating the preliminary search result and the final search result, respectively.

4. A method according to claim 2, further comprising periodically automatically updating the final search result, and storing the updated final search result in the user accessible account.

5. A method according to claim 1, further comprising:
enabling communication with at least one other client device; and
enabling file sharing with the at least one other client device.

6. A method according to claim 5, further comprising storing the final search results in a user accessible account, and enabling the final search results to be communicated to the at least one other client device.

7. A method according to claim 1, wherein the additional terms comprise at least one of author name, publication name, publication date, and publication date range.

8. A method according to claim 1, wherein the additional terms comprise technical terms appearing in the preliminary search results.

9. A method according to claim 1, wherein the frequency indication is expressed as a percentage.

10. A method according to claim 1, further comprising repeating the analyzing step on the final search result and enabling the user to further narrow the final search result.

11. A method of managing a scientific workbench system for access by a client device over a network, the method comprising:
enabling users to establish user accounts providing access to a workbench search engine;
enabling communication with at least one other client device; and
enabling file sharing with the at least one other client device.
